(19) United States
(12) Patent Application Publication
(10) Pub. No.: US 2026/0019396 A1
(43) Pub. Date: Jan. 15, 2026

(54) METHOD, COMPUTER APPARATUS, AND COMPUTER PROGRAM FOR PROVIDING OPENCHAT BRIDGE PAGE FOR EXTERNAL SERVICE LINKAGE

(71) Applicant: LINE Plus Corporation, Seongnam-si (KR)

(72) Inventors: Seo Hyun CHO, Seongnam-si (KR); Daeun JUNG, Seongnam-si (KR); Hyungjung LEE, Seongnam-si (KR); So Yun SEONG, Seongnam-si (KR); Yejin SHIN, Seongnam-si (KR); Gihwan KIM, Seongnam-si (KR); SooKyung PARK, Seongnam-si (KR); Seung Hwan JOO, Seongnam-si (KR); Bokyung KANG, Seongnam-si (KR); Seonu LEE, Seongnam-si (KR)

(73) Assignee: LINE Plus Corporation, Seongnam-si (KR)

(21) Appl. No.: 19/328,586

(22) Filed: Sep. 15, 2025

(30) Foreign Application Priority Data
Mar. 15, 2023 (KR) 10-2023-0034066

(51) Int. Cl. H04L 51/52; G06F 16/955

(52) U.S. Cl. CPC H04L 51/52; G06F 16/9558

(57) ABSTRACT

An openchat providing method, performed by a computer device including at least one processor configured to execute computer-readable instructions included in a memory, includes: generating, as a webpage, a bridge page for linking an openchat service of a social platform with an external service; and generating a link directable to the bridge page to be displayed on a page of the external service.

### CROSS-REFERENCE TO RELATED APPLICATION(S)

This application is a continuation of International Application No. PCT/KR2024/001442, filed on Jan. 31, 2024, in the Korean Intellectual Property Receiving Office, which is based on and claims priority to Korean Patent Application No. 10-2023-0034066, filed on Mar. 15, 2023, in the Korean Intellectual Property Office, the disclosures of which are incorporated by reference herein in their entireties.

### BACKGROUND

### 1. Field

The following description relates to technology for providing an openchat service.

### 2. Description of Related Art

An instant messenger service that is a general communication tool refers to software that allows a user to send and receive messages or data in real time and allows the user to register a contact on a messenger service and may send and receive messages with a counterpart on a contact list in real time.

Such a messenger function is commonly used in a mobile environment of a mobile communication terminal as well as a personal computer (PC).

For example, a mobile messenger service system and method of a portable terminal using a wireless communication network to provide a messenger service between mobile messengers installed on portable terminals is disclosed in Korean Patent Laid-Open Publication No. 10-2002-0074304 (published on Sep. 30, 2002).

The use of an instant messenger service becomes more popular and functions provided through the instant messenger service become more diversified. So, an openchat function that allows a chat using a link without sharing personal information, such as a telephone number or an ID, is being serviced.

### SUMMARY

Provided are an apparatus and method for performing an openchat function in which a user with specific authority may join through linkage with an external service.

Further, provided are an apparatus and method for providing a bridge page with a function of checking authority of an external service account and a messenger service account as a separate webpage.

Further, provided are an apparatus and method which may periodically manage an openchat member based on account information authenticated on a bridge page.

Additional aspects will be set forth in part in the description which follows and, in part, will be apparent from the description, or may be learned by practice of the presented embodiments.

According to an aspect of the disclosure, provided is an openchat providing method performed by a computer device including at least one processor configured to execute computer-readable instructions included in a memory, the openchat providing method may include: generating, as a webpage, a bridge page for linking an openchat service of a social platform with an external service; and generating a link directable to the bridge page to be displayed on a page of the external service.

The link directable to the bridge page may be configured to enable creation of the openchat by an administrator of a channel in the external service, and to enable a joining of the openchat by a member subscribed to the channel.

The openchat providing method may further include: linking, through the bridge page, an account of the external service and an account of the social platform; and processing at least one of a creation of the openchat or a joining of the openchat, using the account of the social platform that is linked to the account of the external service.

The openchat providing method may further include: verifying, in periodic intervals, an authority associated with the openchat, through the account of the external service and the account of the social platform authenticated through the bridge page; and automatically managing membership of the openchat based on a result of the authority verification.

The automatically managing the membership of the openchat may include processing, among joined members of the openchat, a member with an authority that does not meet an openchat join qualification to be withdrawn from the openchat.

The openchat providing may further include: a first operation including linking an account of the external service of an administrator of a channel in the external service, and an account of the social platform of the administrator; a second operation including creating the openchat for the channel using the account of the social platform of the administrator; a third operation including linking, through the bridge page, an account of the external service of a member subscribed to the channel in the external service, and an account of the social platform of the member; and a fourth operation including joining the member to the openchat using the account of the social platform of the member.

The first operation may further include, in response to an access of the bridge page through the link by the administrator in the external service, prompting a log-in to the account of the external service and a log-in to the account of the social platform.

The second operation may further include verifying an authority of the administrator for openchat creation, through the account of the external service and the account of the social platform authenticated on the bridge page.

The third operation may further include, in response to an access of the bridge page through the link by the member subscribed to the channel in the external service, prompting a log-in to the account of the external service and a log-in to the account of the social platform.

The fourth operation may further include verifying an authority of the member, according to an openchat join qualification, through the account of the external service and the account of the social platform authenticated on the bridge page.

According to an aspect of the disclosure, provided is a non-transitory computer-readable recording medium storing a computer-program that, when executed by at least one processor of a computer device, executes the openchat providing method including: generating, as a webpage, a bridge page for linking an openchat service of a social platform with an external service; and generating a link directable to the bridge page to be displayed on a page of the external service.

According to an aspect of the disclosure, a computer device may include: at least one processor configured to execute computer-readable instructions stored on a memory, where, by executing the computer-readable instructions, the at least one processor may be configured to: generate, as a webpage, a bridge page for linking an openchat service of a social platform with an external service, and generate a link directable to the bridge page to be displayed on a page of the external service.

The link directable to the bridge page may be configured to enable creation of an openchat by an administrator of a channel in the external service, and to enable a joining of the openchat by a member subscribed to the channel.

By executing the computer-readable instructions, the at least one processor may be further configured to: link, through the bridge page, an account of the external service and an account of the social platform, and process at least one of a creation of the openchat or a joining of the openchat, using the account of the social platform that is linked to the account of the external service.

By executing the computer-readable instructions, the at least one processor may be further configured to: verify, in periodic intervals, an authority associated with the openchat, through the account of the external service and the account the social platform authenticated through the bridge page, and automatically manage membership of the openchat based on a result of the authority verification.

By executing the computer-readable instructions, the at least one processor may be further configured to: link an account of the external service of an administrator of a channel in the external service, and an account of the social platform of the administrator, create the openchat for the channel using the account of the social platform of the administrator, link, through the bridge page, an account of the external service of a member subscribed to the channel, and an account of the social platform of the member, and join the member to the openchat using the account of the social platform of the member.

By executing the computer-readable instructions, the at least one processor may be further configured to, in response to an access of the bridge page through the link by the administrator, prompt a log-in to the account of the external service and a log-in to the account of the social platform.

By executing the computer-readable instructions, the at least one processor may be further configured to verify an authority of the administrator for openchat creation, through the account of the external service and the account of the social platform authenticated on the bridge page.

By executing the computer-readable instructions, the at least one processor may be further configured to, in response to an access of the bridge page through the link by the member subscribed to the channel in the external service, prompting a log-in to the account of the external service and a log-in to the account of the social platform.

By executing the computer-readable instructions, the at least one processor may be further configured to verify an authority of the member according to an openchat join qualification, through the account of the external service and the account of the social platform authenticated on the bridge page.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating an example of a network environment according to at least one example embodiment;

FIG. 2 is a diagram illustrating a configuration of a computer device according to at least one example embodiment;

FIG. 3 is a flowchart illustrating an example of a method performed by a computer device according to at least one example embodiment;

FIGS. 4, 5, 6, 7, 8, and 9 illustrate examples a process of creating openchat according to at least one example embodiment; and

FIGS. 10, 11, 12, 13, and 14 illustrate examples a process of joining openchat according to at least one example embodiment.

### DETAILED DESCRIPTION

Hereinafter, example embodiments will be described with reference to the accompanying drawings.

The example embodiments relate to technology for providing an openchat service.

Example embodiments including those disclosed herein may provide a separate webpage that may link a social platform with a plurality of external services, and may provide a bridge page for creating openchat which a user with specific authority may join in an external service, as a separate webpage.

An openchat providing system according to some example embodiments may be implemented by at least one computer device, and an openchat providing method according to some example embodiments may be performed by at least one computer device included in the openchat providing system. Here, a computer program according to an example embodiment may be installed and executed on the computer device, and the computer device may perform the openchat providing method according to example embodiments under control of the executed computer program. The aforementioned computer program may be stored in a computer-readable recording medium to computer-implement the openchat providing method in conjunction with the computer device.

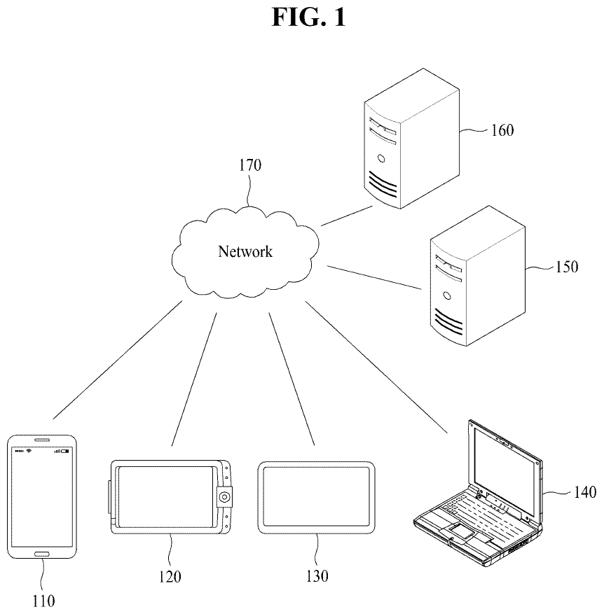

FIG. 1 illustrates an example of a network environment according to at least one example embodiment. The network environment of FIG. 1 may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as one example of environments applicable to the example embodiments, and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., a messenger service) to the plurality of electronic devices 110, 120, 130, and 140 connected over the network 170.

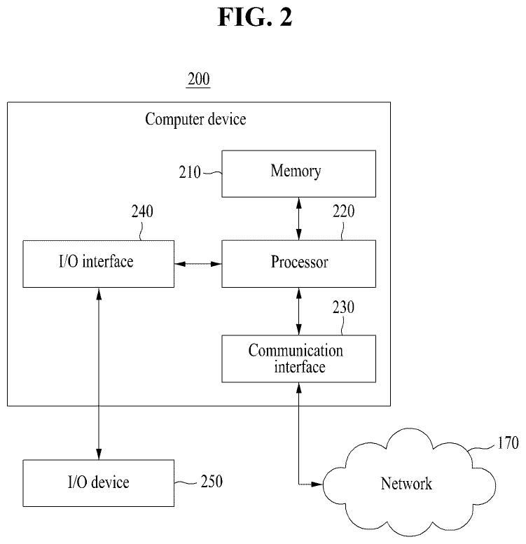

FIG. 2 is a block diagram illustrating an example of a computer device according to at least one example embodiment. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a computer-readable recording medium. The permanent mass storage device, such as ROM and a disk drive, may be included in the computer device 200 as a permanent storage device separate from the memory 210. Also, an operating system (OS) and at least one program code may be stored in the memory 210. Such software components may be loaded to the memory 210 from another computer-readable recording medium separate from the memory 210. The other computer-readable recording medium may include a computer-readable recording medium, for example, a floppy drive, a disk, a tape, a DVD/CD-ROM drive, a memory card, etc. According to other example embodiments, software components may be loaded to the memory 210 through the communication interface 230, instead of the computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the computer device 200 and another apparatus (e.g., the aforementioned storage devices) through the network 170. For example, the processor 220 of the computer device 200 may deliver a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200 over the network 170. For example, a signal, an instruction, data, etc., received through the communication interface 230 may be delivered to the processor 220 or the memory 210, and a file, etc., may be stored in a storage medium (the aforementioned permanent storage device) further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with a device in which an input function and an output function are integrated into a single function, such as a touchscreen. The I/O device 250 may be configured as a single device with the computer device 200.

Also, according to some example embodiments, the computer device 200 may include a greater or smaller number of components than the number of components of FIG. 2. However, illustrations of certain conventional components are omitted. In an embodiment, the computer device 200 may be configured to include at least a portion of the I/O device 250 or may further include other components, such as a transceiver and a database.

Hereinafter, certain example embodiments of a method and apparatus for providing an openchat bridge page for linkage with an external service are described.

A social platform used herein may refer to any service platforms that provide not only a social network service such as various types of communities, but also various types of services using resources such as user profile information and friend relation within the social network service.

The following example embodiments are described using a messenger service as a representative example of the social platform.

To link a messenger service or some functions provided from the messenger service with an external service, it may be implemented in an embedded form of inserting a function for linkage into a corresponding service itself. However, this implementation scheme requires a task of modifying a service itself (native application) to insert a target function.

The example embodiment may provide a bridge page for linkage with an external service in a separate webpage form related to the messenger service. By utilizing a separate webpage that belongs to a single area of the messenger service rather than modifying the service itself, it is possible to reduce the technical burden and to more efficiently perform linkage with various services.

For example, the example embodiment may provide a communication space through an openchat service to a user of an external service by linking an openchat service within a messenger service with various external services through a bridge page.

Herein, openchat refers to a chat service that allows conversations between users on topics of interest. Openchat also represents a community service that allows an immediate chat through a link, such as a uniform resource link (URL), without requiring a friend addition process using a telephone number or an ID. The openchat link may include a function that automatically launches a messenger service and executes a chatroom to make it an immediate chat in response to a click on the link.

The computer device 200 according to the example embodiment may provide a client with a messenger service through connection to a dedicated application installed on the client or a website/mobile site related to the computer device 200. A computer-implemented openchat providing system may be configured in the computer device 200. For example, the openchat providing system may be implemented in an independently operating program form or may be configured in an in-app form of a specific application to be operable on the specific application.

The processor 220 of the computer device 200 may be implemented as a component for performing the following openchat providing method. In some embodiments, the components of the processor 220 may be selectively included in or excluded from the processor 220. Also, in some embodiments, the components of the processor 220 may be separated or merged for functional representations of the processor 220.

The processor 220 and the components of the processor 220 may control the computer device 200 to perform operations included in the following openchat providing method. For example, the processor 220 and the components of the processor 220 may be implemented to execute an instruction according to a code of at least one program and a code of an OS included in the memory 210.

Here, the components of the processor 220 may be representations of different functions performed by the processor 220 according to an instruction provided from a program code stored in the computer device 200.

The processor 220 may read a necessary instruction from the memory 210 to which instructions related to control of the computer device 200 are loaded. In this case, the read instruction may include an instruction for controlling the processor 220 to perform the following operations.

Operations included in the following openchat providing method may be performed in an order different from the illustrated order. Some of the operations may be omitted, or an additional process may be further included.

Operations included in the openchat providing method may be performed by the server 150 and, in some embodiments, at least some of the operations may also be performed by a client.

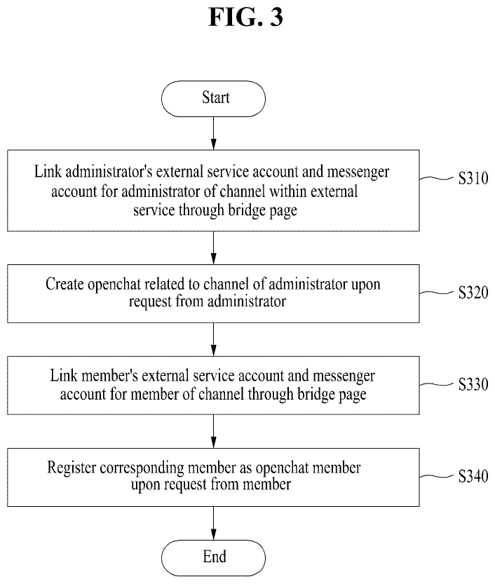

FIG. 3 is a flowchart illustrating an example of a method performed by a computer device according to at least one example embodiment.

Referring to FIG. 3, in operation S310, for an administrator of a channel that operates in an external service, the processor 220 may link the administrator's external service account and messenger account through a bridge page within a messenger service. For example, the processor 220 may generate the bridge page within the messenger service to facilitate the linking of the messenger service with one or more external services. The processor 220 may provide the bridge page that may link the messenger service with a plurality of external services as a separate webpage related to the messenger service. A link to be directed to the bridge page (hereinafter, referred to as ‘openchat bridge link’) may be displayed on an administrator page of the external service, and when the administrator selects the openchat bridge link in the external service, the administrator may be directed to the bridge page. The processor 220 may request log-in to the account of the external service and log-in to the account of the messenger service for the administrator that accesses the bridge page through the openchat bridge link. If log-in to both accounts (external service account and messenger account) is completed through the bridge page, the processor 220 may link the administrator's external service account and messenger account. The processor 220 may activate an interface for creating openchat in response to a success in linkage between the administrator's external service account and messenger account. Here, the processor 220 may check the authority required to create the openchat through the administrator's external service account and messenger account. For example, the processor 220 may verify whether the channel of the administrator is valid and whether the administrator qualifications are valid in the external service through the external service account of the administrator and may verify whether qualifications of the administrator to create openchat are valid in the messenger service through the messenger account of the administrator. The processor 220 may activate an interface for creating the openchat when the authority in the administrator's external service account and messenger account meets openchat creation qualifications.

In operation S320, the processor 220 may create an openchat related to the channel operated by the corresponding administrator in the external service upon request from the administrator, in a state in which the external service account and the messenger account are linked. Here, the processor 220 may create the openchat using the messenger account of the administrator, and may receive, from the administrator, openchat information that includes any one or more of a name, a description, a cover image, a background image, a membership tier to open the openchat, and the like. In some embodiments, it is possible to acquire channel information of the administrator from the external service through the external service account and to apply the channel information as openchat information. For example, a channel name of the channel operated by the administrator in the external service may be used as an openchat name. An openchat profile may display a channel profile of the external service as default, and may be edited by the administrator on the messenger service if necessary. The membership tier of the openchat may be set by the administrator by selecting a minimum tier that allows joining, and may be displayed through a tier classification set by the channel of the external service to select the minimum tier. If the openchat of the administrator is created, the processor 220 may create an invitation link for the corresponding openchat. Here, an openchat invitation link may include a uniform resource locator (URL) that is directed to the bridge page. The administrator may share an openchat invitation link using a community post viewable by a member that subscribes to the channel of the administrator on the external service, or may share the openchat invitation link on a membership-only tier benefit page on the external service.

In operation S330, for a member that subscribes to the administrator channel in the external service through the bridge page, the processor 220 may link the member's external service account and messenger account. When the member of the administrator channel selects the openchat invitation link in the external service, the member of the administrator channel may be directed to the bridge page. For a channel member that accesses the bridge page through the openchat invitation link, the processor 220 may request log-in to the account of the external service and log-in to the account of the messenger service. If log-in to both accounts (external service account and messenger account) is completed through the bridge page, the processor 220 may link the channel member's external service account and messenger account. The processor 220 may activate an interface for joining the openchat in response to a success in linkage between the channel member's external service account and messenger account. Here, the processor 220 may check the authority required for openchat join through the channel member's external service account and messenger account. For example, the processor 220 may verify whether the channel to which the member is subscribing is valid and whether the member's qualifications are valid in the external service through the external service account of the member, and may verify whether openchat join qualifications of the member are valid in the messenger service through the messenger account of the member. For example, the processor 220 may verify whether a tier of the member in the external service is a member with a tier that meets openchat join qualifications set by the administrator. When the authority in the member's external service account and messenger account both meets openchat join qualifications, the processor 220 may activate the interface for openchat joining.

In operation S340, the processor 220 may register the corresponding member as an openchat member upon request from the channel member in a state in which the external service account and the messenger account are linked. The member of the channel operated by the administrator in the external service may be directed to the bridge page through the openchat invitation link, and may log in to both accounts (external service account and messenger account) on the bridge page and then join the corresponding openchat. Here, the processor 220 may join the openchat using the messenger account of the member and may receive profile information (nickname and image to be used in openchat) from the member for openchat join. In some embodiments, it is possible to acquire profile information of the corresponding member from the external service through the external service account and to apply the same as an openchat profile. For example, a nickname used by the member in the external service may be applied as a nickname in openchat. If necessary, the member may edit the profile on the messenger service.

In addition, the processor 220 may periodically verify the authority of the member based on account information authenticated on the bridge page after joining the openchat, and may determine whether to maintain the member's openchat membership. The processor 220 may verify openchat join qualifications at regular intervals for members that are registered to the openchat, and may process a member with unmatching authority to be forcibly withdrawn from the openchat. For example, the processor 220 may manage openchat members by periodically verifying whether the operation of a channel to which a member is subscribing is suspended, whether a tier of the member does not belong to a tier of openchat join qualifications, and the like.

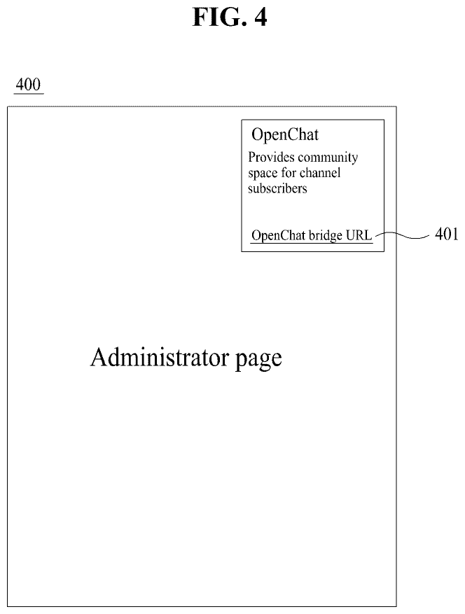

FIGS. 4 to 9 illustrate examples of a process of creating openchat according to at least one example embodiment.

FIG. 4 is an example of an external service screen and shows an administrator page 400 provided to an administrator that operates a channel in an external service. In the external service, an openchat bridge link 401 to be directed to a bridge page may be displayed on the administrator page 400 according to a policy for linkage with an openchat service. When the administrator that operates the channel in the external service selects the openchat bridge link 401 on the administrator page 400, the administrator may be directed to the bridge page.

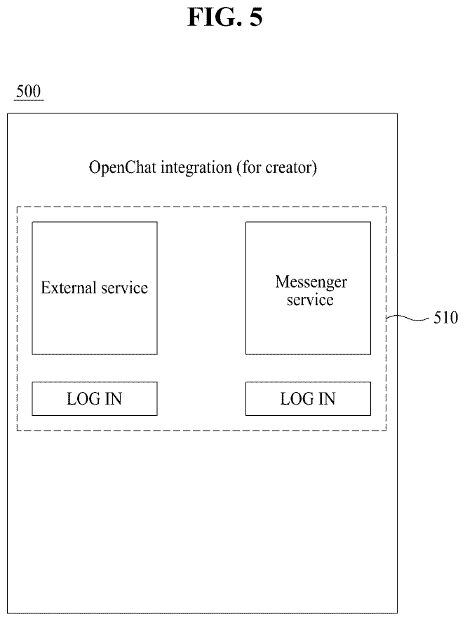

FIG. 5 shows a bridge page screen 500 for an administrator that is accessible through the openchat bridge link 401. A bridge page is to link an openchat service provided from a messenger with various external services (3^{rd} parties), and has a separate webpage structure included in the messenger or linked to the messenger, and has a structure that does not create a separate token for linking with the external service. Objects related to openchat on the messenger service may be directly managed on the bridge page.

Referring to FIG. 5, the bridge page screen 500 may include an area 510 for log-in to an account of the external service and log-in to an account of the messenger service. If the administrator accessed through the openchat bridge link 401 completes log-in to the account of the external service and the account of the messenger service through the bridge page screen 500, the processor 220 may link the administrator's external service account and messenger account.

When the administrator accesses the bridge page screen 500 through the same device, the processor 220 may maintain log-in to the accounts of the external service and the messenger service, and the account linkage.

In response to a success in linkage between the administrator's external service account and messenger account, the processor 220 may check the authority required to create openchat based on account information of the administrator authenticated through the bridge page screen 500. The processor 220 may verify whether the channel of the administrator is valid and may verify whether administrator qualifications are valid in the external service, and may verify whether openchat creation qualifications of the administrator are valid in the messenger service.

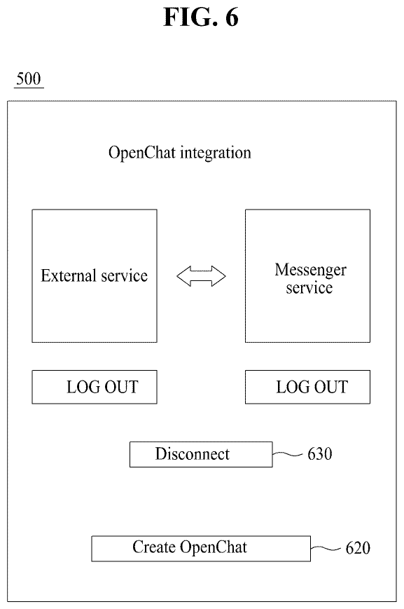

When the authority in the administrator's external service account and messenger account meets the openchat creation qualifications, the processor 220 may activate an openchat creation interface 620 on the bridge page screen 500 as shown in FIG. 6. The processor 220 may activate an unlink button 630 for disconnecting the account linkage between the external service and the messenger service together with the openchat creation interface 620.

In response to a selection on the unlink button 630 on the bridge page screen 500 of FIG. 6, the linkage between the administrator's external service account and messenger account may be disconnected and the screen may be switched to the bridge page screen 500 of FIG. 5.

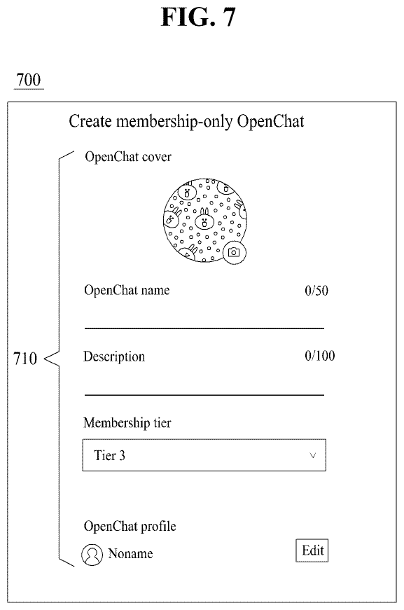

When the administrator selects the openchat creation interface 620 on the bridge page screen 500 of FIG. 6, the processor 220 may provide an openchat creation screen 700 as shown in FIG. 7.

Referring to FIG. 7, the openchat creation screen 700 may include an information input interface 710 for inputting openchat information. The information input interface 710 may include an interface for inputting a cover image, a name, a description, a membership tier, and a profile of the openchat as the openchat information. The processor 220 may automatically insert information of a channel operated by the administrator in the external service and support editing of the same on the information input interface 710. For example, the administrator may insert a cover image of the channel registered to the external service as the cover image of openchat. The membership tier of openchat may be set by the administrator by selecting a minimum tier that allows joining as an openchat member, and may be displayed through a tier classification set by the channel of the external service to select the minimum tier. For example, when members subscribing to the channel in the external service are classified into four levels, an interface may be provided to select a minimum level that allows joining for openchat among four levels as the openchat membership tier. The openchat profile may include a nickname and a profile image to be used by the administrator in openchat. Also, the openchat profile may display profile information used by the administrator in the external service as default, and may be edited depending on the necessity of the administrator.

If all information required to create openchat is input from the administrator, the processor 220 may create the openchat related to the channel that is operated by the corresponding administrator in the external service. Here, the processor 220 may create the openchat using a messenger account of the administrator, and may reflect information input from the administrator through the openchat creation screen 700 to the corresponding openchat. The created openchat may have its own link address. Here, the link address may be created in association with the external service, and the created link address may be stored in association with openchat and external service information.

According to an example embodiment, the created openchat may be associated with at least one openchat chatroom. Here, the openchat may be managed in association with one or a plurality of openchat chatrooms. Here, each of the at least one openchat chatroom associated with the openchat may have its own link address.

According to an example embodiment, the created openchat and at least one openchat chatroom associated with the openchat may be accessible through a messenger application.

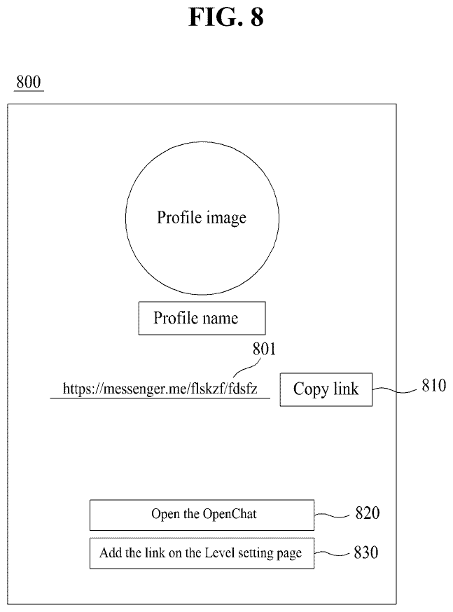

Once openchat creation for the administrator is completed, the processor 220 may provide an openchat execution screen 800 as shown in FIG. 8.

Profile information input from the administrator through the openchat creation screen 700 may be displayed on the openchat execution screen 800. For example, when openchat creation for the administrator is completed, the processor 220 may create a link that directs to a bridge page for openchat join (hereinafter, referred to as ‘openchat invitation link’) 801, and may provide the same on the openchat execution screen 800.

The openchat execution screen 800 may include a ‘copy link’ button 810 for copying the openchat invitation link 801, an openchat link 820 for directing to an openchat chatroom, and a setting page link 830 for directing to a setting page such that the openchat invitation link 801 may be registered for an administrator channel of the external service.

The openchat invitation link 801 may include a URL that directs to the bridge page for openchat join. The administrator may copy the openchat invitation link 801 through the ‘copy link’ button 810 on the openchat execution screen 800 and then, may be directed to the setting page on the external service through the setting page link 830 and may register the openchat invitation link 801. The openchat invitation link 801 registered to the setting page by the administrator may be displayed on a community post, a membership-only tier benefit page, and the like viewable by a member that subscribes to the administrator channel in the external service.

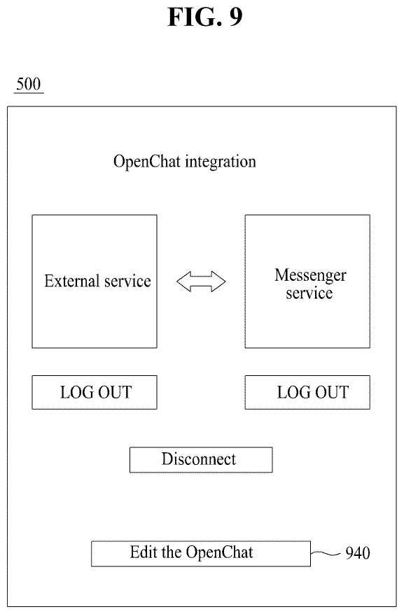

When the administrator that operates the channel in the external service selects the openchat bridge link 401 on the administrator page 400 after openchat creation, the administrator may be directed to the bridge page screen 500 as shown in FIG. 9. Here, after the openchat is created, an openchat edition interface 940 for editing openchat information may be provided on the bridge page screen 500 instead of the openchat creation interface 620.

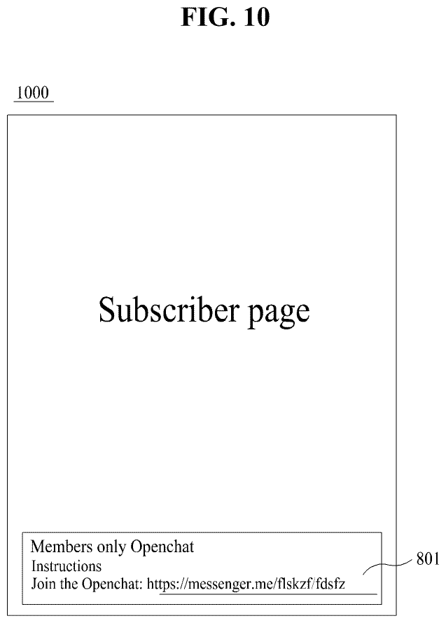

FIGS. 10 to 14 illustrate examples of explaining a process of joining openchat according to at least one example embodiment.

FIG. 10 is an example of an external service screen and shows a subscriber page 1000 provided to a member who subscribes to an administrator channel in an external service. The subscriber page 1000 may utilize a community post, a membership-only tier benefit page, and the like viewable by members who subscribe to the administrator channel. The openchat invitation link 801 registered by the administrator through the setting page on the external service may be displayed on the subscriber page 1000. For example, the openchat invitation link 801 may be displayed through the subscriber page 1000 provided only to a member with specific qualifications, for example, a member who joined a paid membership of the external service, among members who subscribe to the administrator channel. When a member of the administrator channel selects the openchat invitation link 801 on the subscriber page 1000, directing to the bridge page for openchat join may be supported.

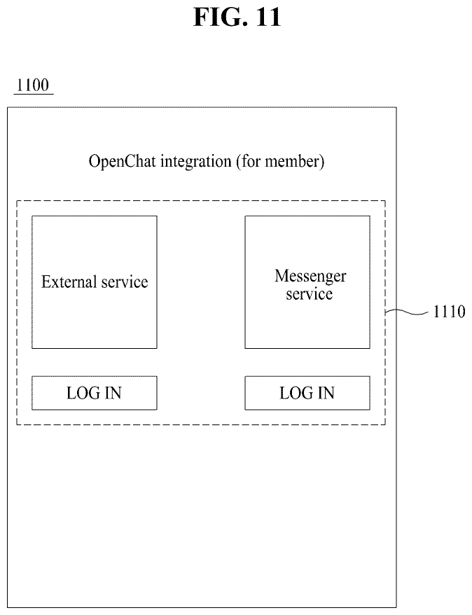

FIG. 11 shows a bridge page screen 1100 for channel members accessible through the openchat invitation link 801. The bridge page screen 1100 provides a function for joining the openchat created by the channel administrator of the external service.

Referring to FIG. 11, the bridge page screen 1100 may include an account log-in area 1110 for log-in to an account of the external service and log-in to an account of the messenger service. When a channel member accessed through the openchat invitation link 801 completes log-in to the accounts of the external service and the messenger service through the bridge page screen 1100, the processor 220 may link the channel member's external service account and messenger account.

When the channel member accesses the bridge page screen 1100 through the same device, the processor 220 may maintain log-in to the accounts of the external service and the messenger service, and account linkage.

In response to a success in linkage between the channel member's external service account and messenger account, the processor 220 may check the authority required to join the openchat based on account information of the channel member authenticated through the bridge page screen 1100. The processor 220 may verify whether the administrator channel to which the member is subscribing in the external service is valid, and whether member qualifications in the corresponding channel are valid, and may verify whether openchat join qualifications of the channel member are valid in the messenger service. For example, the processor 220 may verify whether a tier assigned to the channel member in the external service meets openchat join qualifications set by the administrator.

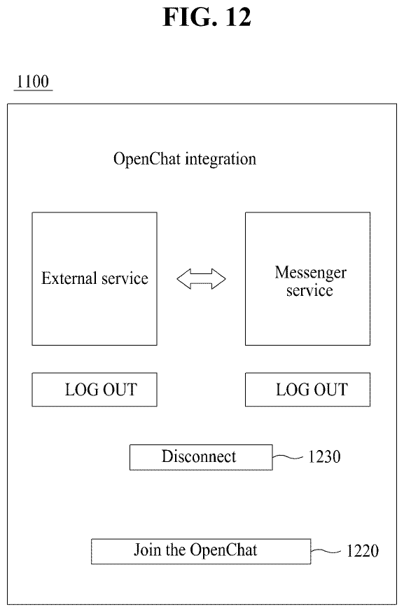

When the authority in the channel member's external service account and messenger account meets the openchat join qualifications, the processor 220 may activate an openchat join interface 1220 on the bridge page screen 1100 as shown in FIG. 12. The processor 220 may also activate an unlink button 1230 for disconnecting the account linkage between the external service and the messenger service together with the openchat join interface 1220.

In response to a selection on the unlink button 1230 on the bridge page screen 1100 of FIG. 12, the linkage between the channel member's external service account and messenger account may be disconnected, and the screen may be switched to the bridge page screen 1100 of FIG. 11.

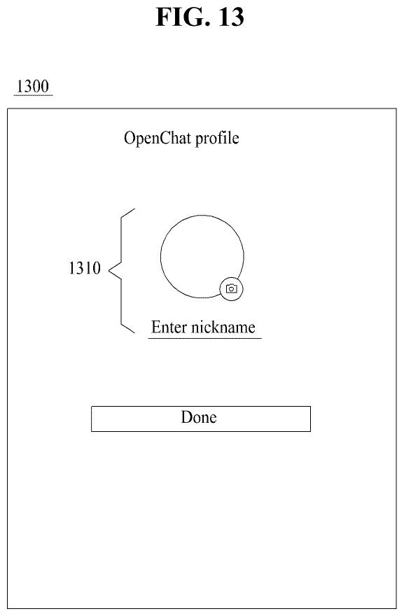

When the channel member selects the openchat join interface 1220 on the bridge page screen 1100 of FIG. 12, the processor 220 may provide an openchat join screen 1300 as illustrated in FIG. 13.

Referring to FIG. 13, the openchat join screen 1300 may include an information input interface 1310 for inputting profile information of the channel member. The information input interface 1310 may include an interface for inputting a nickname and an image for the channel member to use in the openchat. The processor 220 may automatically insert profile information used by the channel member in the external service as default, and may support editing of the same on the information input interface 1310. For example, a profile image registered by the channel member to the external service may be inserted as a profile image of openchat.

When all information required for joining the openchat is input from the channel member, the processor 220 may allow the member to join the openchat created by the corresponding channel administrator. Here, the processor 220 may process openchat joining using the messenger account of the channel member, and may reflect information input from the channel member through the openchat join screen 1300 to the corresponding openchat.

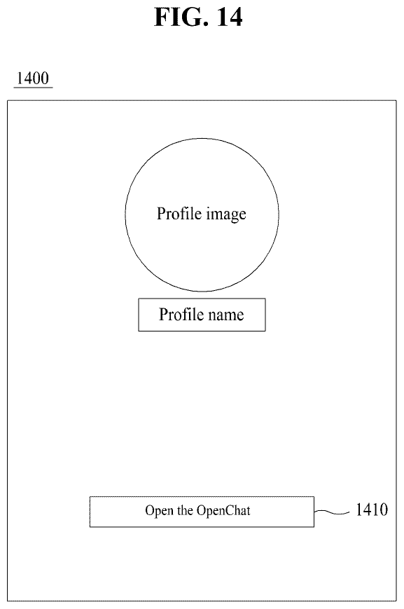

If openchat joining for the channel member is completed, the processor 220 may provide an openchat execution screen 1400 as illustrated in FIG. 14.

Profile information input from the channel member through the openchat join screen 1300 may be displayed on the openchat execution screen 1400, and an openchat link 1410 to direct to a corresponding openchat chatroom may be included.

Although not illustrated, if openchat joining for the channel member is completed, a messenger application may be automatically executed and the joined openchat or an openchat chatroom screen associated with the openchat may be viewed.

The processor 220 may periodically verify the authority of each member for channel members registered to the openchat and may determine whether to maintain openchat membership. When membership qualifications are revoked due to suspension of subscription to the administrator channel or disciplinary action in the external service, a corresponding member may be automatically forcible withdrawn from the corresponding openchat at a point in time at which the membership is revoked. The processor 220 may automatically manage openchat members by periodically checking whether the operation of a channel to which a member is subscribing is suspended in the external service, whether a tier of the member does not belong to a tier of openchat join qualifications, and the like.

According to some example embodiments, by providing a bridge page capable of linking an openchat service provided from a messenger service with an external service in a separate webpage form, it is possible to efficiently link a plurality of external services without technical burden. In addition, according to some example embodiments, through a bridge page of a function that checks the authority of an external service account and a messenger account, it is possible to provide openchat which only a user with specific authority in the external service may join. According to some example embodiments, it is possible to automatically manage openchat members by periodically verifying the authority of an external service account and a messenger account based on account information authenticated on a bridge page.

The apparatuses described above may be implemented using hardware components, software components, and/or combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to some example embodiments may be configured in a form of program instructions performed through various computer methods and recorded in computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store program instructions, such as ROM, RAM, flash memory, and the like. Examples of other media may include recording media and storage media managed by an app store that distributes applications or a site, a server, and the like that supplies and distributes other various types of software.

While some embodiments are described with reference to description and drawings, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, the scope of various embodiments of the disclosure should be interpreted as encompassing all modifications or variations derived based on the technical spirit of various embodiments of the disclosure in addition to the embodiments disclosed herein.

What is claimed is:

1. An openchat providing method performed by a computer device including at least one processor configured to execute computer-readable instructions included in a memory, the openchat providing method comprising:
generating, as a webpage, a bridge page for linking an openchat service of a social platform with an external service; and
generating a link directable to the bridge page to be displayed on a page of the external service.

2. The openchat providing method of claim 1, wherein the link directable to the bridge page is configured to enable creation of the openchat by an administrator of a channel in the external service, and to enable a joining of the openchat by a member subscribed to the channel.

3. The openchat providing method of claim 1, further comprising:
linking, through the bridge page, an account of the external service and an account of the social platform; and
processing at least one of a creation of the openchat or a joining of the openchat, using the account of the social platform that is linked to the account of the external service.

4. The openchat providing method of claim 3, further comprising:
verifying, in periodic intervals, an authority associated with the openchat, through the account of the external service and the account of the social platform authenticated through the bridge page; and
automatically managing membership of the openchat based on a result of the authority verification.

5. The openchat providing method of claim 4, wherein the automatically managing the membership of the openchat comprises processing, among joined members of the openchat, a member with an authority that does not meet an openchat join qualification to be withdrawn from the openchat.

6. The openchat providing method of claim 1, further comprising:
a first operation comprising linking an account of the external service of an administrator of a channel in the external service, and an account of the social platform of the administrator;
a second operation comprising creating the openchat for the channel using the account of the social platform of the administrator;
a third operation comprising linking, through the bridge page, an account of the external service of a member subscribed to the channel in the external service, and an account of the social platform of the member; and
a fourth operation comprising joining the member to the openchat using the account of the social platform of the member.

7. The openchat providing method of claim 6, wherein the first operation further comprises, in response to an access of the bridge page through the link by the administrator in the external service, prompting a log-in to the account of the external service and a log-in to the account of the social platform.

8. The openchat providing method of claim 6, wherein the second operation further comprises verifying an authority of the administrator for openchat creation, through the account of the external service and the account of the social platform authenticated on the bridge page.

9. The openchat providing method of claim 6, wherein the third operation further comprises, in response to an access of the bridge page through the link by the member subscribed to the channel in the external service, prompting a log-in to the account of the external service and a log-in to the account of the social platform.

10. The openchat providing method of claim 6, wherein the fourth operation further comprises verifying an authority of the member, according to an openchat join qualification, through the account of the external service and the account of the social platform authenticated on the bridge page.

11. A non-transitory computer-readable recording medium storing a computer-program that, when executed by at least one processor of a computer device, executes the openchat providing method of claim 1.

12. A computer device comprising:
at least one processor configured to execute computer-readable instructions stored on a memory,
wherein, by executing the computer-readable instructions, the at least one processor is configured to:
generate, as a webpage, a bridge page for linking an openchat service of a social platform with an external service, and
generate a link directable to the bridge page to be displayed on a page of the external service.

13. The computer device of claim 12, wherein the link directable to the bridge page is configured to enable creation of an openchat by an administrator of a channel in the external service, and to enable a joining of the openchat by a member subscribed to the channel.

14. The computer device of claim 12, wherein, by executing the computer-readable instructions, the at least one processor is further configured to:
link, through the bridge page, an account of the external service and an account of the social platform, and
process at least one of a creation of the openchat or a joining of the openchat, using the account of the social platform that is linked to the account of the external service.

15. The computer device of claim 14, wherein, by executing the computer-readable instructions, the at least one processor is further configured to:
verify, in periodic intervals, an authority associated with the openchat, through the account of the external service and the account the social platform authenticated through the bridge page, and
automatically manage membership of the openchat based on a result of the authority verification.

16. The computer device of claim 12, wherein, by executing the computer-readable instructions, the at least one processor is further configured to:
link an account of the external service of an administrator of a channel in the external service, and an account of the social platform of the administrator,
create the openchat for the channel using the account of the social platform of the administrator,
link, through the bridge page, an account of the external service of a member subscribed to the channel, and an account of the social platform of the member, and
join the member to the openchat using the account of the social platform of the member.

17. The computer device of claim 16, wherein, by executing the computer-readable instructions, the at least one processor is further configured to, in response to an access of the bridge page through the link by the administrator, prompt a log-in to the account of the external service and a log-in to the account of the social platform.

18. The computer device of claim 16, wherein, by executing the computer-readable instructions, the at least one processor is further configured to verify an authority of the administrator for openchat creation, through the account of the external service and the account of the social platform authenticated on the bridge page.

19. The computer device of claim 16, wherein, by executing the computer-readable instructions, the at least one processor is further configured to, in response to an access of the bridge page through the link by the member subscribed to the channel in the external service, prompting a log-in to the account of the external service and a log-in to the account of the social platform.

20. The computer device of claim 16, wherein, by executing the computer-readable instructions, the at least one processor is further configured to verify an authority of the member according to an openchat join qualification, through the account of the external service and the account of the social platform authenticated on the bridge page.
